(19) United States
(12) Patent Application Publication
(10) Pub. No.: US 2019/0218350 A1
(43) Pub. Date: Jul. 18, 2019

(54) PROCESS FOR PRODUCING TIRE MEMBER

(71) Applicant: TOYO TIRE & RUBBER CO., LTD., Itami-shi, Hyogo (JP)

(72) Inventor: Makoto Tanaka, Itami-shi (JP)

(73) Assignee: TOYO TIRE CORPORATION, Itami-shi, Hyogo (JP)

(21) Appl. No.: 16/330,462

(22) PCT Filed: May 2, 2017
(86) PCT No.: PCT/JP2017/017256

§ 371 Date: Mar. 5, 2019

(30) Foreign Application Priority Data
Oct. 14, 2016 (JP) 2016-202808

(51) Int. Cl. C08J 3/20; C08K 5/20; C08K 3/04; B60C 1/00

(52) U.S. Cl. CPC C08J 3/20; C08K 5/20; C08L 21/00; B60C 1/00; C08K 3/04

(57) ABSTRACT

A process comprises a step (iii) of dehydrating a filler-containing rubber solidified product to produce the tire member. The step (iii) is a step of adding, into the filler-containing rubber solidified product, a compound represented by formula (I):

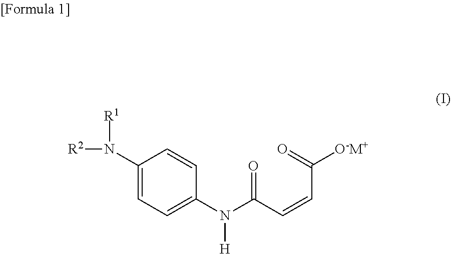

wherein R¹ and R² each represent a hydrogen atom, and an alkyl group, alkenyl group or alkynyl group that has 1 to 20 carbon atoms and R¹ and R² may be the same as or different from each other, and M⁺ represents a sodium ion, potassium ion or lithium ion, and dispersing the compound represented by the formula (I) into the filler-containing rubber solidified product, which contains water, while dehydrating the filler-containing rubber solidified product.

### TECHNICAL FIELD

The present invention relates to a process for producing a tire member yielded by using at least a filler, a dispersing solvent, and a rubber latex solution as raw materials.

### BACKGROUND ART

In the rubber industry, it has been hitherto known that when a tire member is produced which includes a filler such as carbon black, a wet rubber masterbatch is used to improve the workability of the member and the dispersibility of the filler. This manner is a manner of mixing the filler and a dispersing solvent with each other beforehand at a predetermined ratio, dispersing the filler into the dispersing solvent by mechanical force, mixing the resultant filler-containing slurry solution with a rubber latex solution in a liquid phase, adding a solidifier such as an acid, after the mixing, to the mixture to solidify the mixture, collecting the solidified product, and then drying the collected product. The use of the wet rubber masterbatch can give a tire member better in filler-dispersibility and rubber properties such as workability and reinforceability than the use of any dry rubber masterbatch, which is yielded by mixing a filler and a rubber with each other in a solid phase. The use of such a tire member as a raw material allows to produce a rubber product, for example, a pneumatic tire decreased in rolling resistance and excellent in fatigue resistance.

Although the produced tire member may be used immediately after the production thereof, the tire member may be used after stored for a predetermined period. In order to prevent the tire member from being deteriorated in the storage period, it is general to blend an antiaging agent into the tire member as described in, for example, Patent Document 1 listed below. However, when a large amount of the antiaging agent is blended into the tire member, the resultant vulcanized rubber tends to be deteriorated in rubber properties. Thus, the blend amount of the antiaging agent is required to be controlled to be made as low as possible.

### PRIOR ART DOCUMENT

### Patent Document

Patent Document 1: JP-A-2014-95014

### SUMMARY OF THE INVENTION

### Problems to be Solved by the Invention

In the light of the above-mentioned actual situation, an object of the present invention is to provide a process for producing a tire member giving a vulcanized rubber restrained from being lowered in physical properties even when the tire member is stored for a long term.

### Means for Solving the Problems

The object can be attained by the present invention as described in the following: The present invention relates to a process for producing a tire member yielded by using at least a filler, a dispersing solvent, and a rubber latex solution as raw materials, this process including a step (i) of mixing the filler, the dispersing solvent, and the rubber latex solution with each other to produce a filler-containing rubber latex solution, a step (ii) of solidifying the filler-containing rubber latex solution to produce a filler-containing rubber solidified product, and a step (iii) of dehydrating the filler-containing rubber solidified product to produce the tire member; in which the step (iii) is a step of adding, into the filler-containing rubber solidified product, a compound represented by the following formula (I):

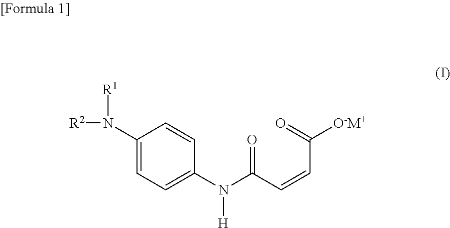

wherein R¹ and R² each represent a hydrogen atom, and an alkyl group, alkenyl group or alkynyl group that has 1 to 20 carbon atoms and R¹ and R² may be the same as or different from each other, and M⁺ represents a sodium ion, potassium ion or lithium ion, and dispersing the compound represented by the formula (I) into the filler-containing rubber solidified product, which contains water, while dehydrating the filler-containing rubber solidified product.

In the step (iii) in this producing process, the compound represented by the formula (I) is dispersed into the filler-containing rubber solidified product, which contains water, while dehydrating the filler-containing rubber solidified product. In general, rubbers used for tires show hydrophobicity in a dry state. In the meantime, the compound represented by the formula (I) shows hydrophilicity. Thus, even when a rubber in a dry state is dry-blended with the compound represented by the formula (I), the dispersibility of the compound represented by the formula (I) is not improved. However, in the above-mentioned producing process, the compound represented by the formula (I) is dispersed into the filler-containing rubber solidified product, which contains water, in the step (iii), which corresponds to a dehydrating step. Accordingly, the compound represented by the formula (I) is dramatically improved in dispersibility by aid of water. As a result, in the filler-containing rubber solidified product, the compound represented by the formula (I) is dispersed at a high level. Once the compound represented by the formula (I) is dispersed in the filler-containing rubber solidified product, the dispersibility of the compound represented by the formula (I) is kept even when the filler-containing rubber solidified product is dehydrated. Thus, also in a tire member yielded by drying the rubber solidified product finally, the dispersibility of the compound represented by the formula (I) is improved. The compound represented by the formula (I) is excellent in antiaging effect, so that physical properties of the finally yielded vulcanized rubber can be kept even when the produced tire member is stored for a long term. In other words, the producing process allows to produce a tire member giving a vulcanized rubber restrained from being lowered in physical properties even when the tire member is stored for a long term.

In the tire member producing process, it is preferred that in a case where at the time of the addition of the compound represented by the formula (I) in the step (iii), the water amount in the filler-containing rubber solidified product is represented by Wa, and the content of the compound represented by the formula (I) in the product, the following is satisfied: 1≤Wa/Wb≤8100. As described above, in the presence of water, the compound represented by the formula (I) is remarkably improved in dispersibility in the filler-containing rubber solidified product by aid of water. In particular, when the expression 1≤Wa/Wb≤8100 is satisfied, the following two can be attained with a good balance: the dispersibility of the compound represented by the formula (I); and the shortening of a period required for removing water in the filler-containing rubber solidified product.

In the tire member producing process, it is preferred that the filler is a carbon black having a nitrogen adsorption specific surface area of 15 to 150 m²/g. The use of the carbon black makes an improvement of the resultant vulcanized rubber, particularly, in exothermicity and viscosity-retention performance. It is therefore possible to produce a tire member which can be restrained from being lowered in exothermicity and viscosity-retention performance even when the tire member is stored for a long term, specific examples of the tire member including a tread, a sidewall, a base tread, a carcass, and a bead filler.

Furthermore, the present invention relates to a process for producing a tire member yielded by using at least a filler and a rubber as raw materials, this process including: adding, into a mixture of the filler and the rubber, a compound represented by the following formula (I):

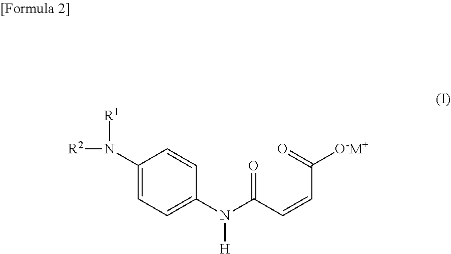

wherein R¹ and R² each represent a hydrogen atom, and an alkyl group, alkenyl group or alkynyl group that has 1 to 20 carbon atoms and R¹ and R² may be the same as or different from each other, and M⁺ represents a sodium ion, potassium ion or lithium ion, and water; and dispersing the compound.

In this tire member producing process, in the presence of water, the compound represented by the formula (I) is dispersed in the mixture of the filler and the rubber. In general, rubbers used for tires show hydrophobicity in a dry state. In the meantime, the compound represented by the formula (I) shows hydrophilicity. Thus, even when a rubber in a dry state is dry-blended with the compound represented by the formula (I), the dispersibility of the compound represented by the formula (I) is not improved. However, in the above-mentioned producing process, the compound represented by the formula (I) is dispersed into the mixture of the filler and the rubber in the presence of water. Accordingly, the compound represented by the formula (I) is dramatically improved in dispersibility by aid of water. As a result, in the mixture of the filler and the rubber, the compound represented by the formula (I) is dispersed at a high level. The compound represented by the formula (I) is excellent in antiaging effect, so that physical properties of the finally yielded vulcanized rubber can be kept even when the finally yielded tire member is stored for a long term. In other words, the producing process allows to produce a tire member giving a vulcanized rubber restrained from being lowered in physical properties even when the tire member is stored for a long term.

In the above-defined tire member producing process, it is preferred that when the addition amount of the water is represented by Wa, and the addition amount of the compound represented by the formula (I) is represented by Wb, the following is satisfied: 1≤Wa/Wb≤8100. As described above, in the presence of water, the compound represented by the formula (I) is remarkably improved in dispersibility in the mixture of the filler and the rubber by aid of water. In particular, when the expression 1≤Wa/Wb≤7500 is satisfied, the following two can be attained with a good balance: the dispersibility of the compound represented by the formula (I); and the shortening of a period required for removing water in the mixture of the filler and the rubber.

In the above-defined producing process of the tire member producing process, it is preferred that the filler is a carbon black having a nitrogen adsorption specific surface area of 15 to 150 m²/g. The use of the carbon black makes an improvement of the resultant vulcanized rubber, particularly, in exothermicity and viscosity-retention performance. It is therefore possible to produce a tire member which can be restrained from being lowered in exothermicity and viscosity-retention performance even when the tire member is stored for a long term, specific examples of the tire member including a tread, a sidewall, a base tread, a carcass, and a bead filler.

### MODE FOR CARRYING OUT THE INVENTION

The tire member producing process according to the present invention makes use of at least a filler, a dispersing solvent, and a rubber latex solution as raw materials.

In the present invention, the filler denotes an inorganic filler used ordinarily in the rubbery industry. Examples of the filler include carbon black, silica, clay, talc, calcium carbonate, magnesium carbonate, and aluminum hydroxide. In the present invention, out of the inorganic fillers, carbon black is in particular preferably usable.

The carbon black is a carbon black used in an ordinary rubbery industry, such as SAF, ISAF, HAF, FEF, or GPF. The carbon black may be an electroconductive carbon black such as acetylene black or Ketchen black. The carbon black may be a granulated carbon black, which has been granulated, considering the handleability of the carbon black in an ordinary rubbery industry; or a non-granulated carbon black.

When a carbon black having a nitrogen adsorption specific surface area of 15 to 150 m²/g is used in the present invention, the resultant vulcanized rubber is excellent in exothermicity and viscosity-keeping performance. Thus, a carbon black having a nitrogen adsorption specific surface area of 15 to 60 m²/g is in particular preferably used as a raw material used for treads, sidewalls, base treads, carcasses, or bead fillers of tires.

The dispersing solvent is in particular preferably water. However, the dispersing solvent may be, for example, water containing an organic solvent.

The rubber latex solution may be any natural rubber latex solution, or synthesized rubber latex solution.

The natural rubber latex solution is a natural product obtained by metabolic effect of a plant. Particularly preferred is a natural-rubber/water based latex solution in which a dispersing solvent is water. About a natural rubber in the natural rubber latex solution used in the invention, the number-average molecular weight thereof is preferably 2,000,000 or more, more preferably 2,500,000 or more. About the natural rubber latex, concentrated latex, fresh latex named field latex, and other latexes are usable without being distinguished from each other. The synthetic rubber latex solution is, for example, a rubber latex solution in which styrene-butadiene rubber, butadiene rubber, nitrile rubber or chloroprene rubber has been produced by emulsion polymerization.

In the case of dehydrating, in the present invention, a filler-containing rubber solidified product yielded by using at least the filler, the dispersing solvent, and the rubber latex solution as raw materials, a compound represented by the following formula (I) is added thereto.

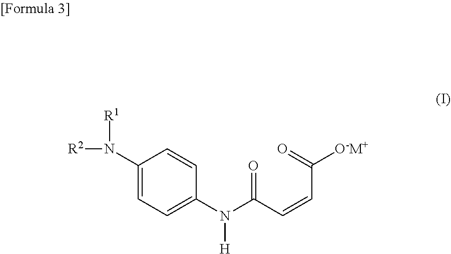

wherein R¹ and R² each represent a hydrogen atom, and an alkyl group, alkenyl group or alkynyl group that has 1 to 20 carbon atoms and R¹ and R² may be the same as or different from each other, and M⁺ represents a sodium ion, potassium ion or lithium ion.

In order to make this compound high in affinity with the filler, particularly, a carbon black, it is particularly preferred to use a compound represented by the following formula (I′), in which R¹ and R² in the formula (I) are each a hydrogen atom and M⁺ is a sodium ion:

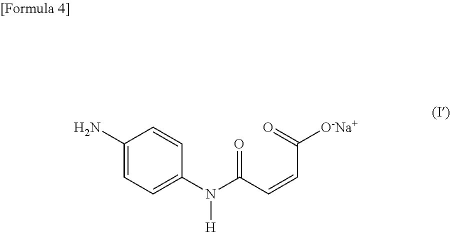

When the total amount of the rubber component included in the tire member is regarded as 100 parts by mass, the blend amount of the compound represented by the formula (I) is preferably from 0.1 to 10 parts by mass, more preferably from 0.5 to 5 parts by mass to restrain physical properties of the resultant vulcanized rubber effectively from being lowered.

Hereinafter, a specific description will be made about the tire member producing process according to the present invention. This producing process is a process for producing a tire member yielded by using at least a filler, a dispersing solvent, and a rubber latex solution as raw materials. This process includes a step (i) of mixing the filler, the dispersing solvent, and the rubber latex solution with each other to produce a filler-containing rubber latex solution, a step (ii) of solidifying the filler-containing rubber latex solution to produce a filler-containing rubber solidified product, and a step (iii) of dehydrating the filler-containing rubber solidified product to produce the tire member. This step (iii) is a step of adding, into the filler-containing rubber solidified product, a compound represented by the formula (I), and dispersing the compound represented by the formula (I) into the filler-containing rubber solidified product, which contains water, while dehydrating the filler-containing rubber solidified product.

### (1) Step (i)

The step (i) includes an operation of mixing a filler, a dispersing solvent, and a rubber latex solution with each other to produce a filler-containing rubber latex solution. In the present invention, the step (i) in particular preferably includes a step (i-(a)) in which when the filler is dispersed into the dispersing solvent, at least one portion of the rubber latex solution is added to this dispersion system to produce a slurry solution containing the filler to which rubber latex particles adhere, and a step (i-(b)) of mixing the slurry solution containing the filler, to which the rubber latex particles adhere, with the rest of the rubber latex solution to produce a rubber latex solution containing the filler to which the rubber latex particles adhere. Hereinafter, a description will be made about the step (i-(a)) and the step (i-(b)). The description will be made, particularly, about an example of using a carbon black as the filler in the present embodiment.

Step (i-(a))

In the step (i-(a)), at the time of dispersing a carbon black into a dispersing solvent, at least one portion of a rubber latex solution is added to this dispersing system to produce a slurry solution containing the carbon black to which rubber latex particles adhere. It is allowable to mix the rubber latex solution beforehand with the dispersing solvent, and then add the carbon black to the mixture to disperse the carbon black in the mixture. It is also allowable to: add the carbon black into the dispersing solvent; and next add the rubber latex solution thereto at a predetermined adding-speed and simultaneously disperse the carbon black in the dispersing solvent. Alternatively, it is allowable to: add the carbon black to the dispersing solvent; and next add thereto a predetermined volume of the rubber latex solution several times through operations separated from each other and simultaneously disperse the carbon black in the dispersing solvent. By dispersing the carbon black into the dispersing solvent in the presence of the rubber latex solution, the slurry solution can be produced, which contains the carbon black to which the rubber latex particles adhere. The addition amount of the rubber latex solution in the step (i-(a)) is, for example, from 0.075 to 12% by mass of the whole of the latex solution to be used (the whole of fractions of this latex solution that are to be added in the step (i-(a)) and in the step (i-(b)).

In the step (i-(a)), the solid (rubber) content in the rubber latex solution to be added is preferably from 0.25 to 15%, more preferably from 0.5 to 6% by mass of the carbon black. The concentration of the solid (rubber) in the rubber latex solution to be added is preferably from 0.2 to 5% by mass, more preferably from 0.25 to 1.5% by mass. In these cases, a tire member can be produced in which the dispersion degree of the carbon black is heightened while the rubber latex particles are surely caused to adhere to the carbon black.

In the step (i-(a)), the method for mixing the carbon black and the dispersing solvent with each other in the presence of the rubber latex solution is, for example, a method of dispersing the carbon black, using an ordinary dispersing machine such as a highly shearing mixer, a High Shear Mixer, a homo-mixer, a ball mill, a bead mill, a high-pressure homogenizer, an ultrasonic homogenizer or a colloid mill.

The “highly shearing mixer” means a mixer having a high-speed-rotatable rotor and a fixed stator in which in the state of making a precise clearance between the rotor and the stator, the rotor is rotated so that a highly shearing effect acts. In order to produce such a highly shearing effect, it is preferred to set the clearance between the rotor and the stator to 0.8 mm or less, and set the circumferential speed of the rotor to 5 m/s or more. Such a highly shearing mixer may be a commercially available product. An example thereof is a mixer, “High Shear Mixer”, manufactured by a company Silverson.

In the present invention, at the time of mixing the carbon black with the dispersing solvent in the presence of the rubber latex solution to produce the slurry solution, which contains the carbon black to which the rubber latex particles adhere, a surfactant may be added thereto in order to improve the carbon black in dispersibility. The surfactant may be a surfactant known in the rubbery industry. Examples thereof include nonionic surfactants, anionic surfactants, cationic surfactants, and amphoteric surfactants. Instead of the surfactant or in addition of the surfactant, an alcohol such as ethanol may be used. However, when the surfactant is used, it is feared that the finally obtained vulcanized rubber is lowered in rubber physical properties. Thus, the blend amount of the surfactant is preferably 2 parts or less by mass, more preferably 1 part or less by mass for 100 parts by mass of the solid (rubber) in the rubber latex solution. It is preferred not to use any surfactant substantially.

Step (i-(b))

In the step (i-(b)), the slurry solution is mixed with the rest of the rubber latex solution to produce a rubber latex solution containing the carbon black to which the rubber latex particles adhere. The method for mixing the slurry solution with the rest of the rubber latex solution in a liquid phase is not particularly limited, and may be a method of mixing the slurry solution with the rest of the rubber latex solution, using an ordinary dispersing machine such as a highly shearing mixer, a High Shear Mixer, a homo-mixer, a ball mill, a bead mill, a high-pressure homogenizer, an ultrasonic homogenizer or a colloid mill. At the time of the mixing, the whole of the mixing system, for example, the dispersing machine may be optionally heated.

Considering the drying period and labor in the next step (iii), the solid (rubber) concentration in the rest of the rubber latex solution is preferably higher than that in the rubber latex solution added in the step (i-(a)). Specifically, the former solid (rubber) concentration is preferably from 10 to 60% by mass, more preferably from 20 to 30% by mass.

### (2) Step (ii)

The step (ii) includes an operation of solidifying the filler-containing rubber latex solution to produce a filler-containing rubber solidified product. The method for the solidification is, for example, a method of incorporating a solidifier into the filler-containing rubber latex solution, in which the rubber latex particles adhere to the filler. In this case, the solidifier may be an acid or salt that is usually used to solidify a rubber latex solution, for example, formic acid, sulfuric acid or sodium chloride. As required, after the step (ii) and before the step (iii), it is allowable to set up a solid-liquid separating step, for example, a centrifugal separation step or a heating step in order to decrease appropriately the water amount contained in the filler-containing rubber solidified product.

(3) Step (iii)

The step (iii) includes an operation of dehydrating the filler-containing rubber solidified product to produce a tire member. In the step (iii), for example, a uniaxial extruder is used to heat the filler-containing rubber solidified product at a temperature of 100 to 250° C. to dehydrate this solidified product while giving shearing force to the solidified product. In the present invention, the step (iii) particularly includes operations of adding, into the filler-containing rubber solidified product, a compound represented by the formula (I), and dispersing the compound represented by the formula (I) into the filler-containing rubber solidified product, which contains water, while dehydrating the filler-containing rubber solidified product. Before the start of the step (iii), the water content by percentage in the filler-containing rubber solidified product is not particularly limited. It is preferred to set up, for example, the solid-liquid separating step as required, so as to adjust the water content by percentage to set the ratio Wa/Wb, which will be detailed later, into an appropriate range.

As described above, by dispersing the compound represented by the formula (I) into the filler-containing rubber solidified product in the presence of water, the compound is remarkably improved in dispersibility. In a case where at the time of the addition of the compound represented by the formula (I), the water amount in the filler-containing rubber solidified product is represented by Wa, and the content of the compound represented by the formula (I) in the product is represented by Wb, it is particularly preferred to satisfy the following: 1≤Wa/Wb≤8100. If the ratio Wa/Wb is less than 1, the compound represented by the formula (I) may not be sufficiently improved in dispersibility in the filler-containing rubber solidified product. In order to improve the compound represented by the formula (I) further in dispersibility, the ratio Wa/Wb is preferably 1 or more. In the meantime, if the ratio Wa/Wb is more than 8100, the amount of water to be removed becomes remarkably large, so that the resultant tire members tend to be deteriorated in producibility. Considering the producibility of the tire members, the ratio Wa/Wb is preferably 7400 or less.

As required after the step (iii), a drying step may be separately set up to decrease the resultant tire member in water content by percentage. In the method for drying the tire member, various drying machines are usable, examples thereof including a uniaxial extruder, an oven, a vacuum drier, and an air drier.

### (4) Step (iv)

As required, in a step (iv), various blending agents are dry-blended into the tire member. Examples of the usable blending agent include a sulfur-containing vulcanizer, a vulcanization promoter, an antiaging agent, silica, a silane coupling agent, zinc oxide, a methylene receptor and a methylene donor, stearic acid, a vulcanization promoting aid, a vulcanization retardant, an organic peroxide, softeners such as wax and oil, a working aid, and other blending agents used ordinarily in the rubbery industry.

The species of sulfur in the sulfur-containing vulcanizer may be any ordinary sulfur species for rubbers. Examples thereof include powdery sulfur, precipitated sulfur, insoluble sulfur, and highly dispersible sulfur. The sulfur content in the tire member according to the present invention is preferably from 0.3 to 6.5 parts by mass for 100 parts by mass of the rubber component. If the sulfur content is less than 0.3 parts by mass, the resultant vulcanized rubber is short in crosslinkage density to be lowered in rubber strength and others. If the content is more than 6.5 parts by mass, the rubber is deteriorated, particularly, in both of heat resistance and endurance. In order to keep the rubber strength of the vulcanized rubber good certainly and improve the heat resistance and the endurance further, the sulfur content is set into a range more preferably from 1.5 to 5.5 parts by mass, even more preferably from 2 to 4.5 parts by mass for 100 parts by mass of the rubber component.

The vulcanization promoter may be a vulcanization promoter usable ordinarily for vulcanizing rubbers. Examples thereof include sulfenamide type, thiuram type, thiazole type, thiourea type, guanidine type, and dithiocarbamic acid salt type vulcanization promoters. These may be used singly or in the form of an appropriate mixture. The vulcanization promoter content is more preferably from 1 to 5 parts by mass, even more preferably from 1.5 to 4 parts by mass for 100 parts by mass of the rubber component.

The antiaging agent may be an antiaging agent usable usually for rubbers, examples thereof including aromatic amine type, amine-ketone type, monophenolic type, bisphenolic type, polyphenolic type, dithiocarbamic acid salt type, and thiourea type antiaging agents. These may be used singly or in the form of an appropriate mixture. The antiaging agent content is more preferably from 1 to 5 parts by mass, even more preferably from 2 to 4.5 parts by mass for 100 parts by mass of the rubber component.

Furthermore, the present invention relates to a process for producing a tire member yielded by using at least a filler and a rubber as raw materials, this process including: adding, into a mixture of the filler and the rubber, a compound represented by the formula (I), and water; and dispersing the compound.

A tire member produced by the producing process according to the present invention is restrained from being deteriorated even when stored over a long term. Thus, a vulcanized rubber produced by using the tire member as a raw material is restrained from being lowered in physical properties. For this reason, the producing process according to the invention is particularly useful as a method for producing a tire member, which is used to undergo a long-term storage as required.

### EXAMPLES

Hereinafter, the present invention will be more specifically described through descriptions about working examples of this invention.

### (Used Materials)

### a) Carbon Black:

Carbon black “N550” (nitrogen adsorption specific surface area: 42 m²/g); “SEAST SO” (manufactured by Tokai Carbon Co., Ltd.),

b) Dispersing solvent: Water,
c) Rubber latex solution:
Natural rubber latex solution (NR field latex) manufactured by a company Golden Hope (DRC=31.2%),
   d) Compound represented by the formula (I):

Sodium (2Z)-4-[(4-aminophenyl)amino]-4-oxo-2-butenoate (manufactured by Sumitomo Chemical Co., Ltd.),

e) Solidifier: Formic acid (first class 85%, a solidifier prepared by diluting a 10% solution thereof and adjusting the diluted solution into a pH of 1.2) “manufactured by Nacalai Tesque, Inc.”,
f) Zinc oxide: ZINC OXIDE No. 3 (manufactured by Mitsui Mining & Smelting Co., Ltd.),
g) Stearic acid: “LUNAC S-20” (manufactured by Kao Corp.), h) Wax: “OZOACE 0355” (manufactured by Nippon Seiro Co., Ltd.),
i) Antiaging agents:

(A) N-phenyl-N′-(1,3-dimethylbutyl)-p-phenylenediamine “6PPD” (manufactured by the company Monsanto), melting point: 44° C.,

(B) 2,2,4-Trimethyl-1,2-dihydroquinoline polymer “RD” (manufactured by Ouchi Shinko Chemical Industrial Co., Ltd.), melting point: 80 to 100° C.,

j) Sulfur: “5%-Oil-incorporated finely powdery sulfur” (manufactured by Tsurumi Chemical Industry Co., Ltd.),
k) Vulcanization promoters: “CBS” (manufactured by Sanshin Chemical Industry Co., Ltd.),

(A) N-cyclohexyl-2-benzothiazole sulfenamide “SANCELER CM” (manufactured by Sanshin Chemical Industry Co., Ltd.), and

(C) 1,3-Diphenylguanidine “NOCCELLAR D” (manufactured by Ouchi Shinko Chemical Industrial Co., Ltd.), and

l) Natural rubber (NR): “RSS#3”

### Examples 1 to 3

In each of the examples, a carbon black was added to a diluted latex solution of a natural rubber in water, this solution having a concentration of 0.52% by mass, to give blend amounts shown in Table 1 (the concentration of the carbon black in water was 5% by mass). Thereto was dispersed the carbon black, using a machine ROBOMIX manufactured by Primix Corp. (ROBOMIX conditions: 9000 rpm for 30 minutes). In this way, a slurry solution was produced which contained the carbon black to which natural rubber latex particles shown in Table 1 adhered (step (i)-(a)). Next, a natural rubber latex solution (25% by mass) was added to the slurry solution produced through the step (i-(a)), which contained the carbon black to which the natural rubber latex particles adhered, to give blend amounts shown in Table 1. Next, a mixer for home use, SM-L56 model, manufactured by SANYO Electric Co., Ltd. was used to mix these components with each other (mixer conditions: 11300 rpm for 30 minutes) to produce a rubber latex solution containing the carbon black, to which the natural rubber latex particles adhered (step (i)).

To the carbon-black-containing natural rubber latex solution produced in the step (i), in which the natural rubber latex particles adhered to the carbon black, was added formic acid, as a solidifier, until the pH of the whole of the solution turned to 4. In this way, a carbon-black-containing natural rubber solidified product was produced (step (ii)). As required, the resultant carbon-black-containing natural rubber solidified product was subjected to a solid-liquid separating step to adjust the solidified product into a water amount shown in Table 1. This adjusted carbon-black-containing natural rubber solidified product and a compound represented by the formula (I) were charged into a screw press, V-01 model, manufactured by SUEHIRO EPM Corp. to disperse the compound represented by the formula (I) in the carbon-black-containing natural rubber solidified product while dehydrating the carbon-black-containing natural rubber solidified product to produce a tire member (step (iii)). The ratio Wa/Wb value in the step (iii) is shown in Table 1.

### Comparative Examples 1 to 3

In Comparative Example 1, a tire member was produced in the same way as in Example 1 except that the compound represented by the formula (I) was not added. In Comparative Example 2, a tire member was produced in the same way as in Example 1 except that: before the step (iii), the carbon-black-containing natural rubber solidified product was dried until the water content by percentage therein turned to U %, and this dry-state carbon-black-containing natural rubber solidified product, which contained no water, was used; and further an antiaging agent (A) was added instead of the compound represented by the formula (I). In Comparative Example 3, a tire member was produced in the same way as in Example except that before the step (iii), the carbon-black-containing natural rubber solidified product was dried until the water content by percentage therein turned to 0%, and this dry-state carbon-black-containing natural rubber solidified product, which contained no water, was used.

The storage stability of each of the resultant tire members was evaluated, using the Mooney viscosity thereof as a basis. Specifically, a measurement was made in accordance with JIS K-6300-1 about the Mooney viscosity of the tire member of each of the working examples and the comparative examples immediately after the production of the tire member. The tire member was stored at room temperature for 3 months, and then the Mooney viscosity of the tire member was again measured. In the evaluation, the Mooney viscosity of each of the tire members immediately after the production was regarded as 100. After the tire member was stored at room temperature for the 3 months, the Mooney viscosity of the tire member was subjected to an index evaluation relative thereto. It is meant that as the numerical value thereof is nearer to 100, the tire member is better in long-term storage stability. The results are shown in Table 1.

A Banbury mixer was used to dry-blend various blending agents shown in Table 1 into the tire member yielded in each of Examples 1 to 3, and Comparative Examples 1 to 3 (step (iv)). In Table 1, the blend proportion of each of the components is represented by the numerical value of parts by mass (phr) thereof when the total amount of the corresponding rubber component was regarded as 100 parts by mass.

The storage stability of each of the resultant tire members was evaluated, using the tan δ of a vulcanized rubber of this member as a basis. The tire member produced in each of Examples 1 to 3, and Comparative Examples 1 to 3 was vulcanized at 150° C. for 30 minutes immediately after the production thereof. About the resultant vulcanized rubber sample, the tan δ thereof was evaluated in accordance with JIS K6265. Specifically, a rheospectrometer E4000 manufactured by a company UBM was used to measure the tan δ at 50 Hz and 80° C. under a condition that the dynamic strain was 2%. The value of Comparative Example 1 was regarded as 100, and the other examples were each subjected to an index evaluation relative thereto. Next, the tire member produced in each of Examples 1 to 3, and Comparative Examples 1 to 3 was stored at room temperature for 3 months, and then vulcanized at 150° C. for 30 minutes. The tan δ of the resultant vulcanized rubber sample was evaluated in the same way. In the evaluation, the tan δ of the vulcanized rubber of each of the tire members immediately after the production was regarded as 100. After the tire member was stored for the 3 months, the tan δ of the vulcanized rubber of the tire member was subjected to an index evaluation relative thereto. It is meant that as the numerical value thereof is nearer to 100, the tire member is better in storage stability. The results are shown in Table 1.

TABLE 1

| | | | Comparative | Comparative | Comparative | Example | Example | Example |
|---|---|---|---|---|---|---|---|---|
| | | | Example 1 | Example 2 | Example 3 | 1 | 2 | 3 |
| Step (iii) | Natural rubber (solid content) | part(s) by mass/phr | 100 | 100 | 100 | 100 | 100 | 100 |
| | Carbon black | part(s) by mass/phr | 70 | 70 | 70 | 70 | 70 | 70 |
| | Antiaging agent (A) | part(s) by mass/phr | — | 3 | — | — | — | — |
| | Compound (I) | part(s) by mass/phr | — | — | 3 | 3 | 3 | 3 |
| | Water | part(s) by mass/phr | 200 | — | — | 200 | 4 | 22100 |
| | Wa/Wb | — | — | — | 0 | 67 | 1.4 | 7400 |
| Step (iv) | Zinc oxide | part(s) by mass/phr | 3 | 3 | 3 | 3 | 3 | 3 |
| | Stearic acid | part(s) by mass/phr | 2 | 2 | 2 | 2 | 2 | 2 |
| | Wax | part(s) by mass/phr | 2 | 2 | 2 | 2 | 2 | 2 |
| | Antiaging agent (A) | part(s) by mass/phr | 2 | 2 | 2 | 2 | 2 | 2 |
| | Antiaging agent (B) | part(s) by mass/phr | 1 | 1 | 1 | 1 | 1 | 1 |
| | Sulfur | part(s) by mass/phr | 2 | 2 | 2 | 2 | 2 | 2 |
| | Vulcanization promoter (A) | part(s) by mass/phr | 1.5 | 1.5 | 1.5 | 1.5 | 1.5 | 1.5 |
| | Vulcanization promoter (B) | part(s) by mass/phr | 0.5 | 0.5 | 0.5 | 0.5 | 0.5 | 0.5 |

| | | | | | | | |
|---|---|---|---|---|---|---|---|
| Storage | Mooney viscosity (Moony viscosity of each of tire members | 62 | 83 | 84 | 98 | 99 | 99 |
| stability | immediately after production thereof = 100) | | | | | | |
| of tire | tanδ of vulcanized rubber of tire member immediately after | 100 | 110 | 107 | 98 | 99 | 99 |
| member | production thereof (tanδ of vulcanized rubber of tire | | | | | | |
| | member of Comparative Example 1 = 100) | | | | | | |
| | tanδ of vulcanized rubber of tire member after storage | 120 | 113 | 112 | 102 | 101 | 102 |
| | thereof at room temperature for 3 months (tanδ of | | | | | | |
| | vulcanized rubber of each of rubber compositions | | | | | | |
| | immediately after production thereof = 100) | | | | | | |

### Example 4, and Comparative Examples 4 to 5

In each of the examples, the following components were dry-blended with each other at respective blend proportions shown in Table 2 to produce a tire member: a natural rubber; a carbon black; a compound represented by the formula (I); and water. The storage stability of the resultant tire member was evaluated in the same way as described above. The results are shown in Table 2.

Furthermore, a Banbury mixer was used to dry-blend the resultant tire member, and various blending agents shown in Table 2 with each other. In this way, respective tire members according to Example 4 and Comparative Examples 4 to 5 were produced. In Table 2, the blend proportion of each of the components is represented by the numerical value of parts by mass (phr) thereof when the total amount of the corresponding rubber component was regarded as 100 parts by mass. About the tan δ of a vulcanized rubber sample yielded by vulcanizing each of the tire members immediately after the production thereof at 150° C. for 30 minutes, the value of Comparative Example 4 was regarded as 100, and the value of each of the other examples was subjected to an index evaluation relative thereto. About the tan δ of a vulcanized rubber of each of the tire members after the tire member was stored for 3 months, the value of the vulcanized rubber of the tire member immediately after the production thereof was regarded as 100, and the value of each of the examples was subjected to an index evaluation relative thereto. The results are shown in Table 2.

TABLE 2

| | | | Comparative | Comparative | |
|---|---|---|---|---|---|
| | | | Example 4 | Example 5 | Example 4 |
| Tire member production | Natural rubber (solid content) | part(s) by mass/phr | 100 | 100 | 100 |
| | Carbon black | part(s) by mass/phr | 70 | 70 | 70 |
| | Compound (I) | part(s) by mass/phr | — | 3 | 3 |
| | Water | part(s) by mass/phr | — | — | 6 |
| | Wa/Wb | — | — | — | 2 |
| +Various blending agents | Zinc oxide | part(s) by mass/phr | 3 | 3 | 3 |
| | Stearic acid | part(s) by mass/phr | 2 | 2 | 2 |
| | Wax | part(s) by mass/phr | 2 | 2 | 2 |
| | Antiaging agent (A) | part(s) by mass/phr | 2 | 2 | 2 |
| | Antiaging agent (B) | part(s) by mass/phr | 1 | 1 | 1 |
| | Sulfur | part(s) by mass/phr | 2 | 2 | 2 |
| | Vulcanization promoter (A) | part(s) by mass/phr | 1.5 | 1.5 | 1.5 |
| | Vulcanization promoter (B) | part(s) by mass/phr | 0.5 | 0.5 | 0.5 |

| | | | | |
|---|---|---|---|---|
| Storage stability of | Mooney viscosity (Moony viscosity of each | 65 | 82 | 97 |
| tire member | of tire members immediately after | | | |
| | production thereof) | | | |
| | tanδ of vulcanized rubber of tire member | 100 | 108 | 99 |
| | immediately after production thereof (tanδ of | | | |
| | vulcanized rubber of tire member of | | | |
| | Comparative Example 1 = 100) | | | |
| | tanδ of vulcanized rubber of tire member after | 119 | 114 | 101 |
| | storage thereof at room temperature for 3 months | | | |
| | (tanδ of vulcanized rubber of each of rubber | | | |
| | compositions immediately after production | | | |
| | thereof = 100) | | | |

1. A process for producing a tire member yielded by using at least a filler, a dispersing solvent, and a rubber latex solution as raw materials,
the process comprising a step (i) of mixing the filler, the dispersing solvent, and the rubber latex solution with each other to produce a filler-containing rubber latex solution, a step (ii) of solidifying the filler-containing rubber latex solution to produce a filler-containing rubber solidified product, and a step (iii) of dehydrating the filler-containing rubber solidified product to produce the tire member,
wherein the step (iii) is a step of adding, into the filler-containing rubber solidified product, a compound represented by formula (I): 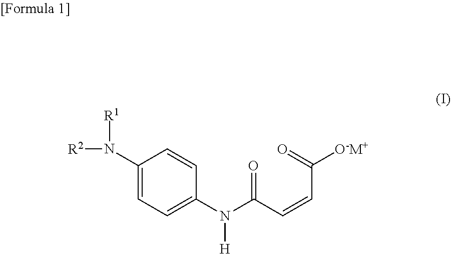
wherein R¹ and R² each represent a hydrogen atom, and an alkyl group, alkenyl group or alkynyl group that has 1 to 20 carbon atoms and R¹ and R² may be the same as or different from each other, and M⁺ represents a sodium ion, potassium ion or lithium ion, and dispersing the compound represented by the formula (I) into the filler-containing rubber solidified product, which contains water, while dehydrating the filler-containing rubber solidified product.

2. The tire member producing process according to claim 1, wherein in a case where at the time of the addition of the compound represented by the formula (I) in the step (iii), a water amount in the filler-containing rubber solidified product is represented by Wa, and a content of the compound represented by the formula (I) in the product, the following is satisfied: 1≤Wa/Wb≤8100.

3. The tire member producing process according to claim 1, wherein the filler is a carbon black having a nitrogen adsorption specific surface area of 15 to 150 m²/g.

4. A process for producing a tire member yielded by using at least a filler and a rubber as raw materials,
the process comprising: adding, into a mixture of the filler and the rubber, a compound represented by formula (I): 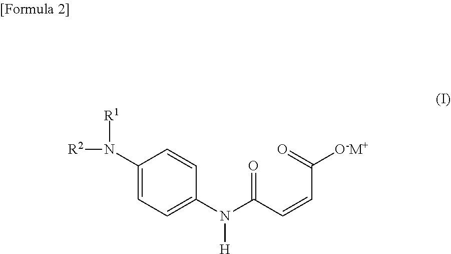
wherein R¹ and R² each represent a hydrogen atom, and an alkyl group, alkenyl group or alkynyl group that has 1 to 20 carbon atoms and R¹ and R² may be the same as or different from each other, and M⁺ represents a sodium ion, potassium ion or lithium ion, and water; and dispersing the compound.

5. The tire member producing process according to claim 4, wherein when an addition amount of the water is represented by Wa, and an addition amount of the compound represented by the formula (I) is represented by Wb, the following is satisfied: 1≤Wa/Wb≤8100.

6. The tire member producing process according to claim 4, wherein the filler is a carbon black having a nitrogen adsorption specific surface area of 15 to 150 m²/g.
